(19) United States
(12) Patent Application Publication
(10) Pub. No.: US 2021/0350790 A1
(43) Pub. Date: Nov. 11, 2021

(54) SYSTEMS AND METHODS FOR INFERRING THE LANGUAGE OF MEDIA CONTENT ITEM

(71) Applicant: Spotify AB, Stockholm (SE)

(72) Inventors: Lucas MAYSTRE, London (GB); Nagarjuna KUMARAPPAN, London (GB)

(21) Appl. No.: 16/868,399

(22) Filed: May 6, 2020

(51) Int. Cl. G10L 15/00; G06F 16/683; G06F 16/635

(52) U.S. Cl. CPC G10L 15/005; G06F 16/635; G06F 16/685

(57) ABSTRACT

An electronic device associated with a media-providing service obtains metadata for a collection of media content items. The metadata specifies an initial value for a language of the audio of a respective media content item. The electronic device obtains a listening history for users of the media-providing service. The listening history specifies which media content items of the collection of media content items a respective user has listened to. The electronic device determines, for a first user, one or more languages corresponding to the first user based on the initial values of the languages of the audio of the media content items that the respective user has listened to. The electronic device determines, for the respective media content item, an updated value for the language of the audio based on the one or more languages corresponding to the users that have listened to the respective media content item.

### TECHNICAL FIELD

The disclosed embodiments relate generally to determining the language of media content, and, in particular, to using listenership to determine the language of media content that include audio.

### BACKGROUND

Access to electronic media, such as music and video content, has expanded dramatically over time. As a departure from physical media, media content providers stream media to electronic devices across wireless networks, improving the convenience with which users can digest and experience such content.

As it becomes easier for users to find content, media content providers can organize media content items and group related content items together in order to provide users with a convenient and straightforward way to find relevant content. In many cases, information included in metadata or text data corresponding to the media content can be searchable in order to identify media content relevant to a user's query. Additionally, it can be useful for the media content itself to be searchable. One method of providing access to information in the media content is by transcribing audio of the media content. For example, audio from a song, podcast, audiobook, or video may be transcribed into text, allowing information stored in the audio to be cataloged and queried. Additionally, transcription of audio when the language of the audio is known leads to improved accuracy in the transcription. Conventional methods of determining a language of audio content include manual (e.g., human) labeling and natural language processing.

### SUMMARY

There is a need for systems and methods for determining a language of media content (also referred to herein as media content item). This technical problem is further exacerbated by incorrectly manually-labeled metadata, incorrect determinations based on natural language processing methods, or the use of different languages in a title or a description of media content compared to the language of the audio in the media content itself.

Some embodiments described herein offer a technical solution to these problems by determining and updating metadata indicating the language of media content based on languages of listeners of the media content (e.g., using statistical methods). To do so, the systems and methods described herein determine a language for a media content item based on the languages of users that listen to the media content item. By determining a language of a media content item using information other than metadata provided by a creator (e.g., producer, author) of the media content item, the systems and methods mitigate the problem of incorrect language assignment due to human error or inaccuracies in natural language processing methods. Additionally, by providing an accurate language identifier associated with a media content item, transcription of the media content item can be performed with improved accuracy and fewer errors.

For example, a podcast may include a title and/or a description that is written in English, and/or metadata that specifies that the podcast is in English. However, the podcast may be in a different language from English, such as Dutch. While information in the metadata (e.g., the title and description) do not accurately reflect the language of the podcast, the language of a podcast is reflected in the languages of its listeners since a listener of a podcast is likely to be able to understand the language of the podcast. Additionally, a person is unlikely to listen to a podcast in a language that they do not understand.

To that end, in accordance with some embodiments, a method is performed at an electronic device that is associated with a media-providing service. The electronic device has one or more processors and memory storing instructions for execution by the one or more processors. The method includes obtaining metadata for a collection of media content items that include audio. The metadata specifies, for a respective media content item of the collection of media content items, an initial value for a language of the audio. The method includes obtaining a listening history for a plurality of users of the media-providing service. The listening history specifies, for each respective user of the plurality of users, which media content items of the collection of media content items the respective user has listened to. For a first user of the plurality of users, the method includes determining one or more languages corresponding to the first user based on the initial values of the languages of the audio of the media content items that the respective user has listened to. For the respective media content item of the collection of media content items, the method includes determining an updated value for the language of the audio based on the one or more languages corresponding to the users that have listened to the respective media content item.

In accordance with some embodiments, a computer system that is associated with a media-providing service includes one or more processors and memory storing one or more programs configured to be executed by the one or more processors. The one or more programs include instructions for obtaining metadata for a collection of media content items that include audio. The metadata specifies, for a respective media content item of the collection of media content items, an initial value for a language of the audio. The one or more programs further include instructions for obtaining a listening history for a plurality of users of the media-providing service. The listening history specifies, for each respective user of the plurality of users, which media content items of the collection of media content items the respective user has listened to. The one or more programs further include instructions for determining, for a first user of the plurality of users, one or more languages corresponding to the first user based on the initial values of the languages of the audio of the media content items that the respective user has listened to. The one or more programs further include instructions for determining, for the respective media content item of the collection of media content items, an updated value for the language of the audio based on the one or more languages corresponding to the users that have listened to the respective media content item.

In accordance with some embodiments, a computer-readable storage medium has stored therein instructions that, when executed by a server system that is associated with a media-providing service, cause the server system to obtain metadata for a collection of media content items that include audio. The metadata specifies, for a respective media content item of the collection of media content items, an initial value for a language of the audio. The instructions further cause the server system to obtain a listening history for a plurality of users of the media-providing service. The listening history specifies, for each respective user of the plurality of users, which media content items of the collection of media content items the respective user has listened to. The instructions further cause the server system to determine, for a first user of the plurality of users, one or more languages corresponding to the first user based on the initial values of the languages of the audio of the media content items that the respective user has listened to. The instructions further cause the server system to determine, for the respective media content item of the collection of media content items, an updated value for the language of the audio based on the one or more languages corresponding to the users that have listened to the respective media content item.

Thus, systems are provided with improved methods for determining the language of media content items that are provided by a media-providing service.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1A is a block diagram illustrating a media content delivery system, in accordance with some embodiments.

FIG. 1B illustrates identifying languages for users and media content items in a media content delivery system, in accordance with some embodiments.

FIG. 2 is a block diagram illustrating a client device, in accordance with some embodiments.

FIG. 3 is a block diagram illustrating a media content server, in accordance with some embodiments.

FIG. 4 is a flow diagram illustrating a method of determining a language of a media content item, in accordance with some embodiments.

FIG. 5A illustrates assigning initial languages to media content items, in accordance with some embodiments.

FIG. 5B illustrates determining languages of users using initial language values of media content items, in accordance with some embodiments.

FIG. 5C illustrates determining updated languages for media content items based on languages of users, in accordance with some embodiments.

FIG. 5D illustrates updating languages of users using updated languages for media content items, in accordance with some embodiments.

FIG. 5E illustrates updating languages of media content items based on updated languages of users, in accordance with some embodiments.

FIGS. 6A-6D are flow diagrams illustrating a method of determining a language for a media content item based on languages of users, in accordance with some embodiments.

FIGS. 7A-7D illustrate a graphical user interface configured to display media content items in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first set of parameters could be termed a second set of parameters, and, similarly, a second set of parameters could be termed a first set of parameters, without departing from the scope of the various described embodiments. The first set of parameters and the second set of parameters are both sets of parameters, but they are not the same set of parameters.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

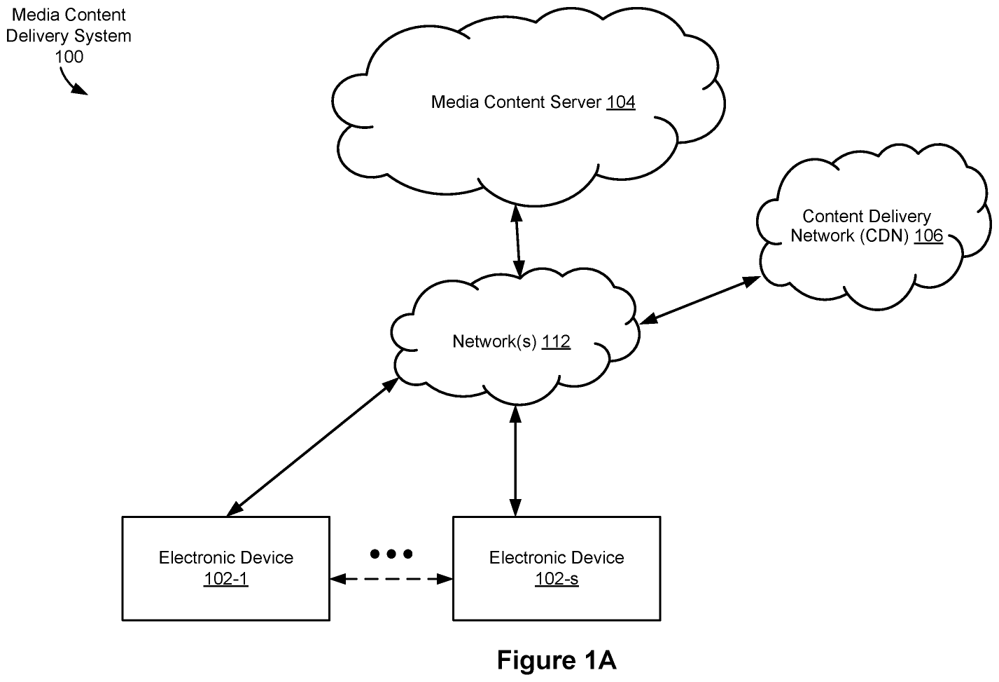

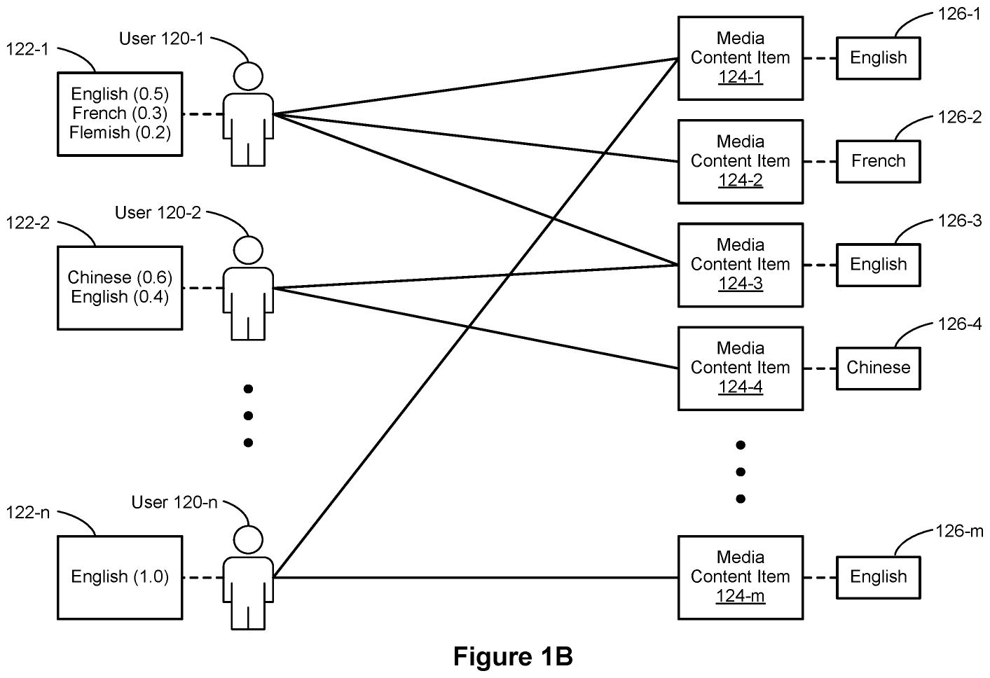

FIG. 1A is a block diagram illustrating a media content delivery system 100, in accordance with some embodiments. The media content delivery system 100 includes one or more electronic devices 102 (e.g., electronic device 102-1 to electronic device 102-s, where s is an integer greater than one), one or more media content servers 104, and/or one or more content delivery networks (CDNs) 106. The one or more media content servers 104 are associated with (e.g., at least partially compose) a media-providing service. The one or more CDNs 106 store and/or provide one or more content items (e.g., to electronic devices 102). In some embodiments, the one or more CDNs 106 are associated with the media-providing service. In some embodiments, the CDNs 106 are included in the media content servers 104. One or more networks 112 communicably couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, digital media player, a speaker, television (TV), digital versatile disk (DVD) player, and/or any other electronic device capable of presenting media content (e.g., controlling playback of media items, such as music tracks, videos, etc.). Electronic devices 102 may connect to each other wirelessly and/or through a wired connection (e.g., directly through an interface, such as an HDMI interface). In some embodiments, an electronic device 102 is a headless client. In some embodiments, electronic devices 102-1 and 102-s are the same type of device (e.g., electronic device 102-1 and electronic device 102-s are both speakers). Alternatively, electronic device 102-1 and electronic device 102-s include two or more different types of devices.

In some embodiments, electronic devices 102-1 and 102-s send and receive media-control information through network(s) 112. For example, electronic devices 102-1 and 102-s send media control requests (e.g., requests to play music, movies, videos, or other media items, or playlists thereof) to media content server 104 through network(s) 112. Additionally, electronic devices 102-1 and 102-s, in some embodiments, also send indications of media content items to media content server 104 through network(s) 112. In some embodiments, the media content items are uploaded to electronic devices 102-1 and 102-s before the electronic devices forward the media content items to media content server 104.

In some embodiments, electronic device 102-1 communicates directly with electronic device 102-s (e.g., as illustrated by the dotted-line arrow), or any other electronic device 102. As illustrated in FIG. 1A, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-s. In some embodiments, electronic device 102-1 communicates with electronic device 102-s through network(s) 112. In some embodiments, electronic device 102-1 uses the direct connection with electronic device 102-s to stream content (e.g., data for media items) for playback on the electronic device 102-s.

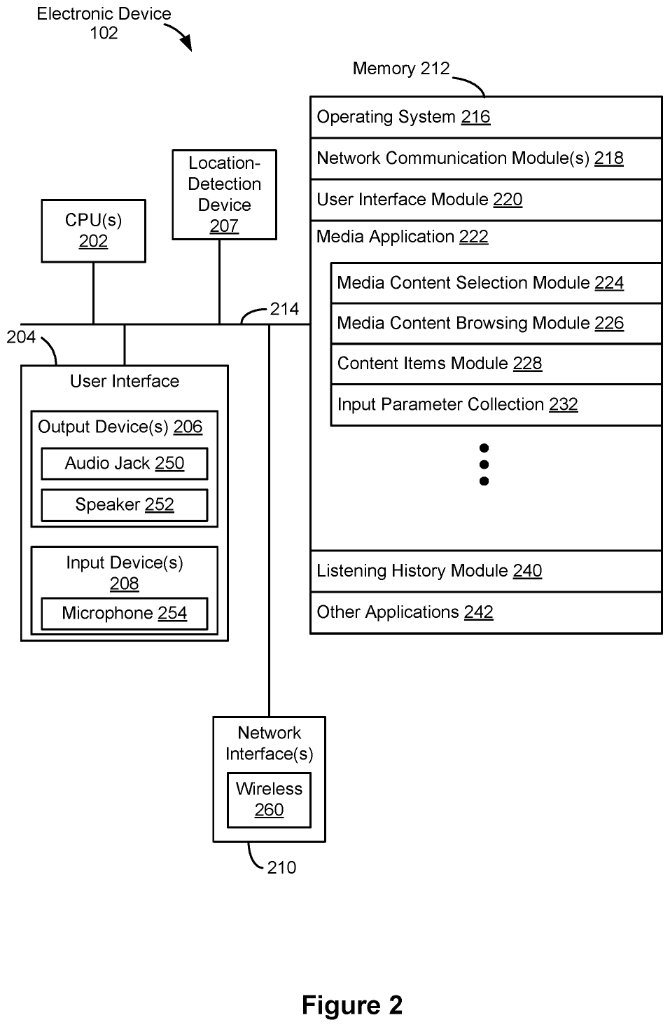

In some embodiments, electronic device 102-1 and/or electronic device 102-s include a media application 222 (FIG. 2) that allows a respective user of the respective electronic device to upload (e.g., to media content server 104), browse, request (e.g., for playback at the electronic device 102), and/or present media content (e.g., control playback of music tracks, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). In some embodiments, the electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, and/or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

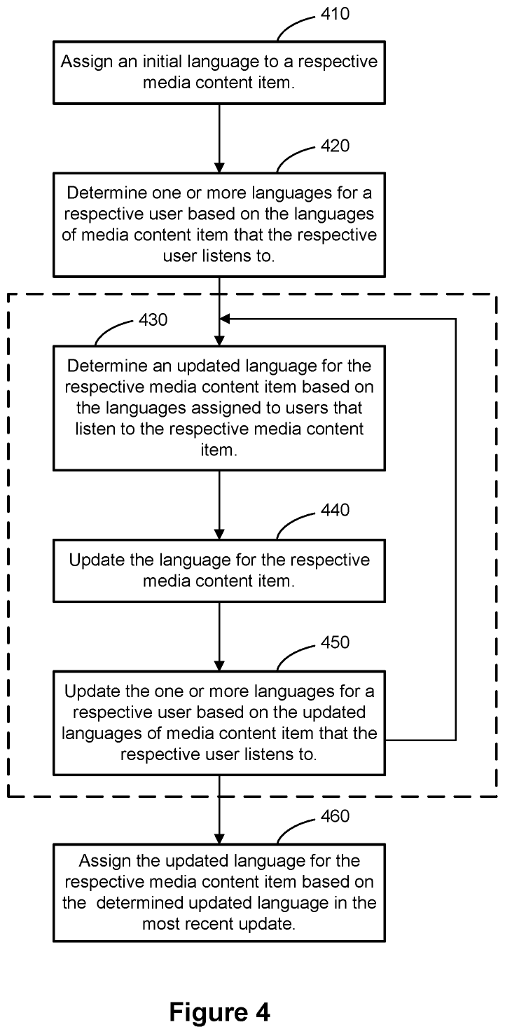

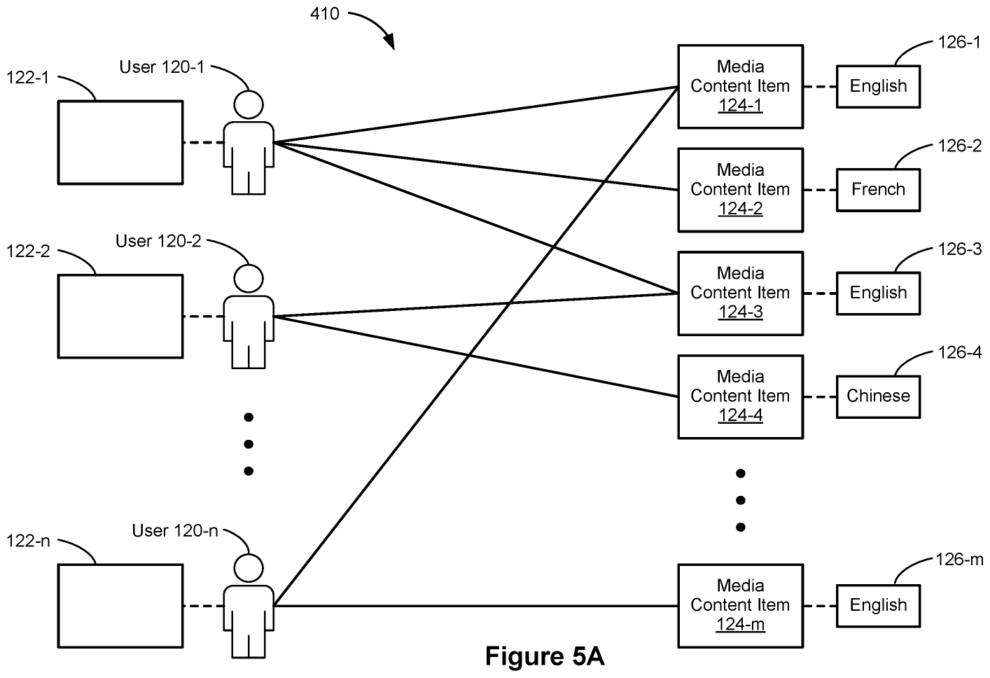

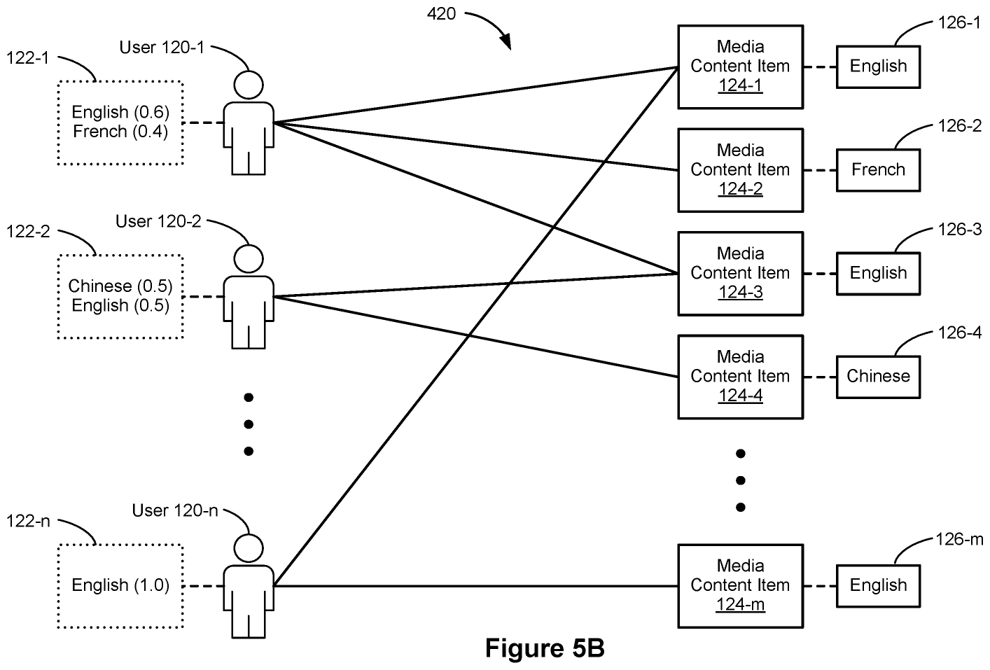

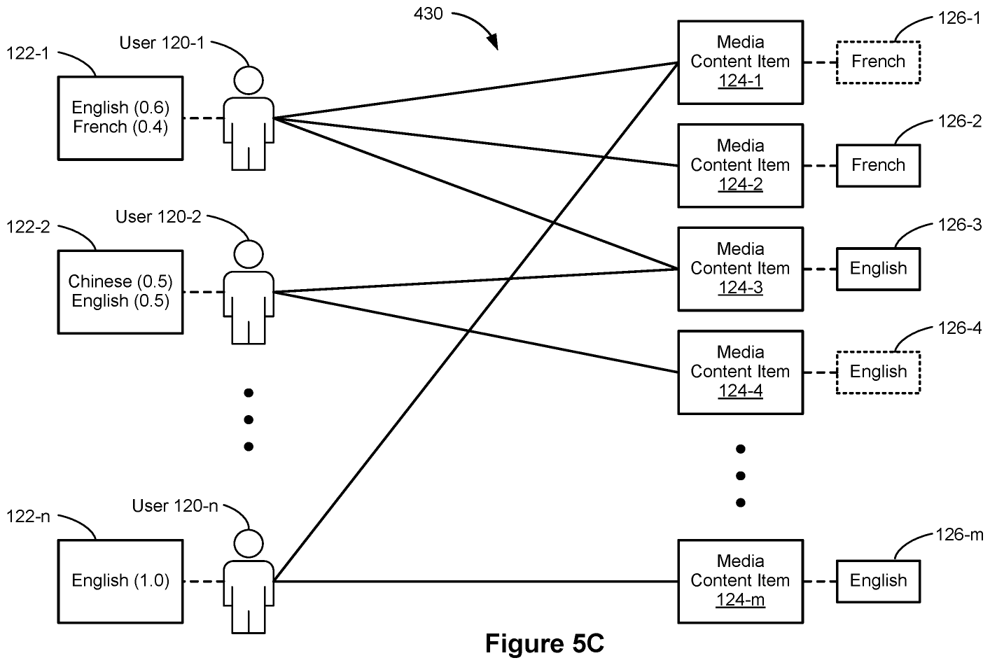

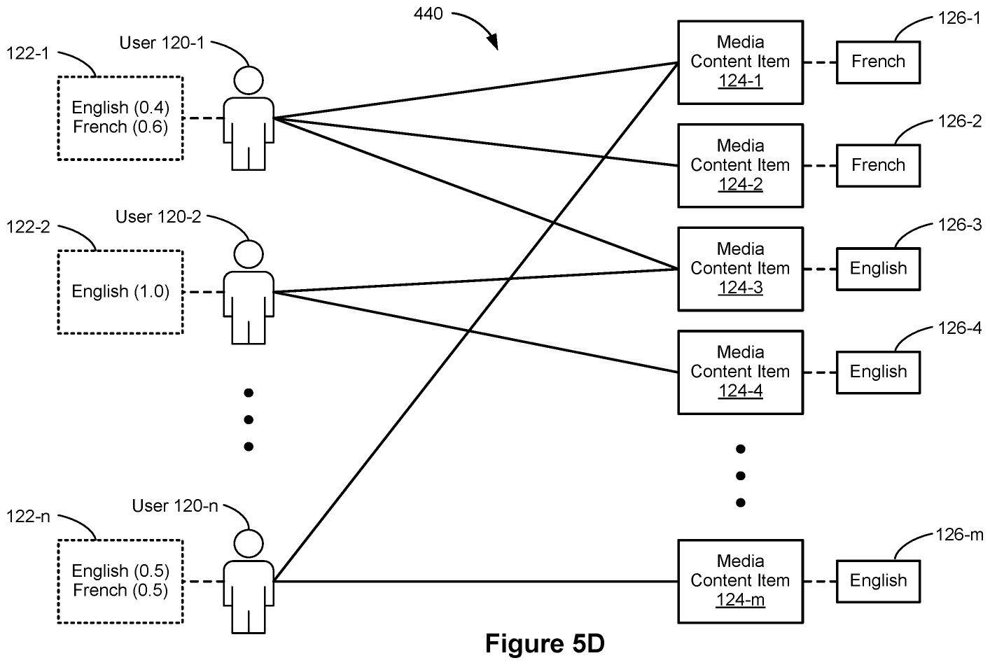

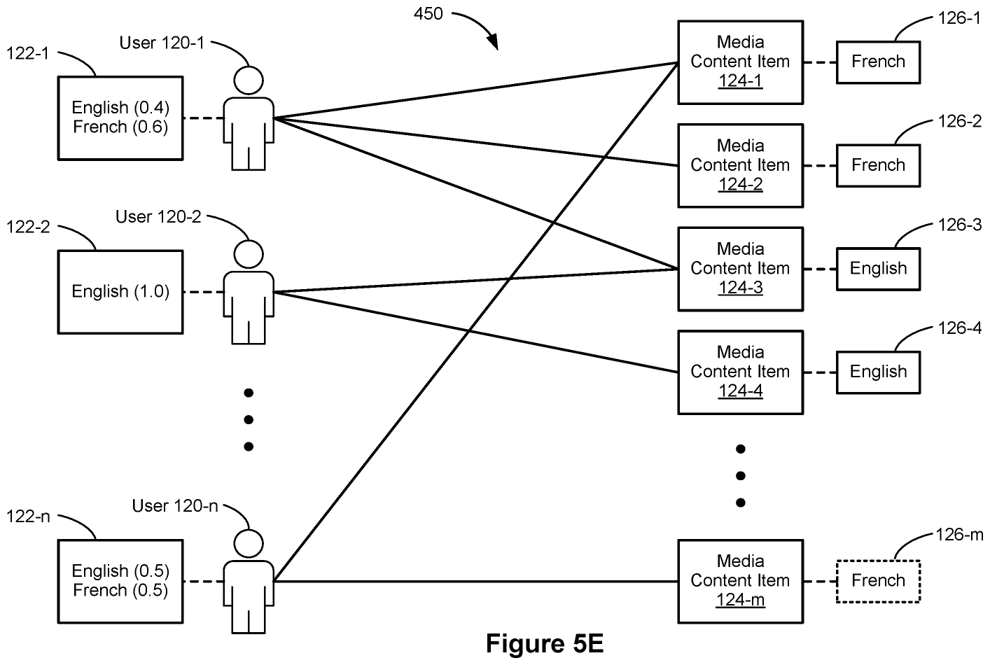

FIG. 1B a illustrates identifying languages for users 120 and media content items 124 in a media content delivery system 100, in accordance with some embodiments. Media content delivery system 100 is configured to provide, via a media-providing service, media content items 124 to users 120 of the media-providing service. Each media content item 124 is associated with a language indicator 126 that includes values corresponding to at least one language. For example, the language indicator 126-1 associated with the media content item 124-1 shows that the media content item 124-1 is determined to include content in the English language. In a second example, language indicator 126-2 shows that the media content item 124-2 is determined to include content in the French language. Similarly, each user also has an associated language profile 122-1 that includes values (e.g., affinity values) corresponding to one or more languages that the user is determined to know (e.g., understand, have a level of proficiency in, be fluent in, speaks, has listening fluency, has listening proficiency). In some embodiments, the language profile 122 of a user 120 is determined based, at least in part, on any of: information provided in the user's profile (such as identified languages, user location, device location) and the user's listening history. For example, user 120-n may be new to the media-providing service and has not listened to or interacted with any media content items on the media-providing service and a user profile for user 120-n may indicate that the user lives in Australia. Thus, user 120-n is determined to know English since the official language of Australia is English. In a second example, user 120-1 may indicate that he/she lives in Belgium and thus is determined to know French and Flemish. However, user 120-1 may also have listened to or interacted with media content items that are in English. Thus, user 120-1 is determined to know at least some English, some French, and some Flemish. In a third example, user 120-2 may indicate, in his/her user profile, the he/she knows or is interested in media content items that are in English and/or Chinese. Thus, user 120-2 is determined to know English and Chinese. FIG. 1B illustrates a framework that associates one or more languages to each user 120 and associates at least one language to each media content item 124. Note that these initial estimates of a user's languages (e.g., based on nationality) may be incorrect. Thus, as will be shown below with respect to FIGS. 4 and 5A-5E, language(s) associated with each user 120 and language(s) associated with each media content item 124 can be updated. While FIG. 1B illustrates that a language indicator is the name of the language in English text (e.g., “English” is used as an indicator for the English language), a language indicator can be in any format. For example, a language indicator can be any of: a text-based indicator (e.g., ENG for English), a numerical indicator (e.g., 0023 for Japanese), an icon or symbol (e.g., a flag of Thailand for Thai), etc.

FIG. 2 is a block diagram illustrating an electronic device 102 (e.g., electronic device 102-1 and/or electronic device 102-s, FIG. 1A), in accordance with some embodiments. The electronic device 102 includes one or more central processing units (CPU(s), i.e., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include an audio jack 250 (or other physical output connection port) for connecting to speakers, earphones, headphones, or other external listening devices and/or speaker 252 (e.g., speakerphone device). Furthermore, some electronic devices 102 use a microphone and voice recognition device to supplement or replace the keyboard. Optionally, the electronic device 102 includes an audio input device (e.g., a microphone 254) to capture audio (e.g., speech from a user).

Optionally, the electronic device 102 includes a location-detection device 207, such as a global navigation satellite system (GNSS) (e.g., GPS (global positioning system), GLONASS, Galileo, BeiDou) or other geo-location receiver, and/or location-detection software for determining the location of the electronic device 102 (e.g., module for finding a position of the electronic device 102 using trilateration of measured signal strengths for nearby devices).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, and/or or other wireless (e.g., Bluetooth-compatible) devices (e.g., for streaming audio data to the electronic device 102 of an automobile). Furthermore, in some embodiments, the wireless interface 260 (or a different communications interface of the one or more network interfaces 210) enables data communications with other WLAN-compatible devices (e.g., electronic device(s) 102) and/or the media content server 104 (via the one or more network(s) 112, FIG. 1A).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the electronic device 102 to other computing devices (e.g., other electronic device(s) 102, and/or media content server 104) via the one or more network interface(s) 210 (wired or wireless) connected to one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with media content server 104) for uploading, browsing, receiving, processing, presenting, and/or requesting playback of media (e.g., media items). In some embodiments, media application 222 includes a media player, a streaming media application, and/or any other appropriate application or component of an application. In some embodiments, media application 222 is used to monitor, store, and/or transmit (e.g., to media content server 104) data associated with user behavior. In some embodiments, media application 222 also includes the following modules (or sets of instructions), or a subset or superset thereof:
   a media content selection module 224 for selecting one or more media content items and/or sending, to the media content server, an indication of the selected media content item(s);
   a media content browsing module 226 for providing controls and/or user interfaces enabling a user to navigate, select for playback, and otherwise control or interact with media content, whether the media content is stored or played locally or remotely;
   a content items module 228 for storing media items for playback at the electronic device;
   an input parameter collection module 232 for collecting, storing and/or creating (e.g., curating) input parameter collections indicating a current context of the user (e.g., time of day, location, device);
a listening history module 240 (sometimes referred to as a playback history module) for storing (e.g., as a list for each user) media content items that have been presented (e.g., streamed, provided, downloaded, played) to a respective user and/or analyzing playback patterns for one or more users;
other applications 242, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

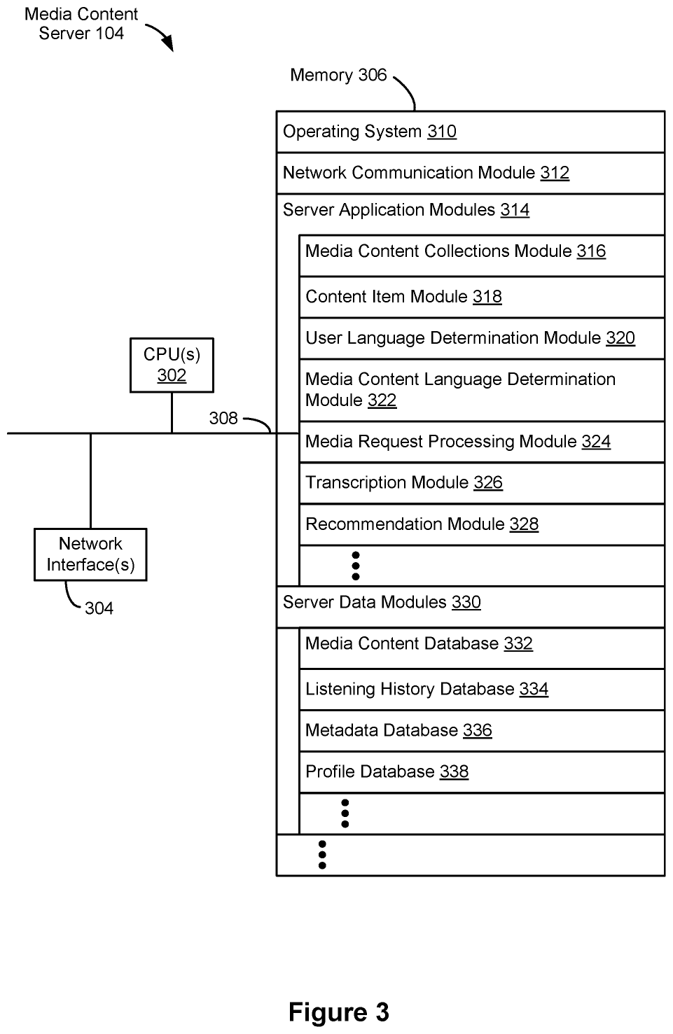

FIG. 3 is a block diagram illustrating a media content server 104, in accordance with some embodiments. The media content server 104 typically includes one or more central processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via one or more network interfaces 304 (wired or wireless) connected to one or more networks 112;
one or more server application modules 314 for performing various functions with respect to providing and managing a content service, the server application modules 314 including, but not limited to, one or more of:
   a media content collections module 316 for storing and/or creating (e.g., curating) media content collections, each media content collection associated with one or more descriptor terms (e.g., playlist titles and/or descriptions) and/or including one or more media content items;
   a content item collection module 318 for collecting and storing media items for playback;
   a user language determination module 320 for determining and/or storing language(s) (e.g., language indicator(s), value(s) corresponding to language(s)) associated with users of the media-providing service;
   a media content language determination module 322 for determining and/or storing language(s) (e.g., language indicator(s), value(s) corresponding to language(s)) associated media content items (e.g., podcasts, songs, movies, short stories, shows) of the media-providing service;
   a media request processing module 324 for processing requests for media content and facilitating access to requested media items by electronic devices (e.g., the electronic device 102) including, optionally, streaming media content to such devices;
   a transcription module 326 for transcribing and storing audio of media content items into text;
   a recommendation module 328 for recommending one or more media content items to a user of the media-providing service;
one or more server data module(s) 330 for handling the storage of and/or access to media items and/or metadata relating to the media items; in some embodiments, the one or more server data module(s) 330 include:
   a media content database 332 for storing media content items;
   a listening history database 334 (also referred to as a playback history database) for storing (e.g., as a list for each user) media content items that have been consumed (e.g., streamed, listened, viewed) by a respective user;
   a metadata database 336 for storing metadata relating to the media items; and
   profile database 338 for storing user profiles (e.g., user information) of users of the media-providing service.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above. In some embodiments, memory 212 stores one or more of the above identified modules described with regard to memory 306. In some embodiments, memory 306 stores one or more of the above identified modules described with regard to memory 212.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 336 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system handles during peak usage periods as well as during average usage periods.

FIG. 4 illustrates a flow diagram of a method of determining a language of a media content item in a media-providing service, in accordance with some embodiments. In step 410, an initial language is assigned to a respective media content item. For example, a first media content item may be determined to be in English based on the metadata including a title and/or a description that is written in English. In step 420, one or more languages are determined for a respective user of the media-providing service based on a listening history of the respective user. For example, a first user may be determined to know (e.g., be fluent in, proficient in, understands, has listening fluency, has listening proficiency, speaks) Japanese based on information included in the first user's profile (e.g., preferred language=Japanese, or location=Japan). In step 430, an updated language is determined for the respective media content item based on the languages assigned to users that listen to the respective media content item. For example, the listening history of users of the media-providing service may indicate that 500 users are listeners of the first media content item. Of the 500 users that are listeners of the first media content item, there are 3 languages that are determined to be known across the 500 users: Dutch, Korean, and English. Of the 500 listeners, each listener (e.g., all 500 listeners) is determined to know Dutch, 403 listeners are determined to know Korean, and 342 listeners are determined to know English. Based on this information, an updated language for the first media content item is determined to be Dutch (since all listeners of the first media content item are determined to know Dutch). In step 440, the language for the respective media content item is updated. Following the example above, the language of the first media content item is changed from English to Dutch. In step 450, the language(s) of the respective user is updated based on the user's listening history and the languages associated with media content items of which the respective user is a listener. For example, as the first user continues to listen to more media content items provided by the media-providing service, the listening history of the user is updated. While the first user has indicated that he or she is located in Japan, the first user may listen to media content items that are both in English and Japanese (e.g., the first user listens to 6 podcasts that are in English and 4 podcasts that are in Japanese). Thus, the language profile of the first user is updated to indicate that the first user knows both Japanese and English. Steps 430 through 450 can be repeated any number of times so that the languages of media content items and the languages of users of the media-providing service are updated with each iteration. In some embodiments, steps 430-450 are repeated until the results converge (e.g., do not change with subsequent or additional iterations). In some embodiments, steps 430-450 are repeated a predetermined number of times (e.g., 10 times, 50 times, 100 times). In some embodiments, steps 430-450 are repeated when a new media content item or a new user is added to the media-providing service. In some embodiments, steps 430-450 are repeated when metadata for a media content item has been updated (e.g., a description is updated or a language identifier is updated). In some embodiments, steps 430-450 are repeated when a user profile is updated (e.g., a language preference is updated). In some embodiments, steps 430-450 are repeated at predetermined times (e.g., time intervals, scheduled updates, once every quarter). Once steps 430-450 have been repeated a sufficient number of times (e.g., the predetermined number of iterations, until the results converge), the updated language for the respective media content item, as determined in the most recent iteration (e.g., most recent update), is assigned to the respective media content item. Following the example above, as the first media content item increases its listenership and both the languages of media content items and the languages of users are updated, the first media content item may be determined to be in Dutch.

In some embodiments, the method of determining a language of a media content item 124 as outlined in FIG. 4 uses Bayesian updating to determine the language of media content items 124 as well as the language(s) of users 120 who interact with (e.g., listen to, play) the media content items 124.

A model used to perform the Bayesian updating includes:
k number of languages;
n number of users, where uᵢ is a distribution over k languages for the i^{th} user (e.g., a distribution of languages for the first user is u₁ and a distribution of languages for the n^{th} user is uₙ); and
m number of media content items, where vⱼ is a language for the j^{th} media content item (e.g., a language for the first media content item is v₁ and a language for the m^{th} media content item is vₘ).

For the ith user, the distribution uᵢ is expressed as uᵢ∈Δ^{k-1}, where Δ^{k-1}={x∈[0,1]^{k}:Σₖ xₖ=1}. In other words, the distribution uᵢ of languages for an i^{th} user includes k number of affinity values x, one affinity value x for each language. The affinity value x can be any value from 0 to 1, and the sum of all affinity values for the i^{th} user equals to 1. In some embodiments, as reflected in the examples shown herein, an affinity value x of zero indicates that a user does not know that language and a non-zero affinity value x indicates that the user knows (or has some familiarity with) that language. Thus, each user has a language distribution uᵢ that includes k number of affinity values. Thus, for a distribution over 10 languages (e.g., k=10), a user who knows 2 languages would have 10 affinity values x, where 2 of the affinity values would be non-zero and the other 8 affinity values would be zero.

For the j^{th} media content item, the language is vⱼ∈[k]. In other words, vⱼ is a single value that corresponds to a specific language. For example, for a j^{th} media content item, vⱼ=Spanish. The value of vⱼ may also be a numerical value, such as vⱼ=1 for Arabic or vⱼ=22 for Spanish.

Thus, the set of distributions u of the languages of all n number of users is u=(u₁, u₂, . . . , uₙ), and the set of languages v of the languages of all m number of media content items is v=(v₁, v₂, . . . , vₘ). Initial values (e.g., a priori beliefs) of the set of distributions u of languages over n number of users and the set of v of languages over m number of media content items are dependent on user information (e.g., information from user profiles and/or user listening histories) and metadata of media content items, respectively.

In some embodiments, the initial language value vⱼ for the j^{th} media content item is determined using metadata associated with the media content item. For example, the language value vⱼ for the j^{th} media content item may be determined based on a language indicator that is provided by a creator of the media content item. In another example, the language value vⱼ for the j^{th} media content item may be determined based on natural language processing of information in the metadata (e.g., a title or description) of the media content item. In a third example, the language value vⱼ for the j^{th} media content item may be determined based on a location of a producer (e.g., production company) that is listed in the metadata associated with the media content item.

In some embodiments, for a given user, the initial affinity values x for each language are determined based on the languages of media content items that the user engages with (e.g., interacts with, listens, plays, watches). For example, a user that listens to podcasts in English and movies in Tagalog may have affinity values that are non-zero for English and Tagalog (and affinity values of zero for other languages). In another example, a user that listens only to podcasts in Kazakh may have affinity value of 1 for Kazakh (and affinity values of zero for other languages). In some embodiments, a user's affinity value for a language is determined based on a frequency (e.g., how often) or an amount (e.g., how much time) with which the user engages with a media content item in that language. For example, a first user that listens to 10 podcasts in Arabic and 10 podcasts in French may have affinity values of 0.5 for Arabic and 0.5 for French. Alternatively, the first user may have listened to 70 hours of Arabic podcasts in the past year compared to 30 hours of podcasts in French and thus, the first user may have affinity values of 0.7 for Arabic and 0.3 for French.

In some embodiments, for a given user, the initial affinity values x for each language are determined based on information in the user's profile. For example, a user who lists Belgium as his/her country may have initial affinity values of 0.5 for Flemish and 0.5 for French. In another example, a user who includes, in his/her user profile, that he/she would like recommendations of media content items that are in German (or that are produced by a specific production company that is known to be based in Germany) may have an affinity value of 1 for German. In a third example, a user who includes that he/she knows (e.g., speaks) Russian in his/her user profile may have an affinity value of 1 for Russian. More than one piece of information in the user's profile may be used to determine initial affinity values. For example, a second user that lists Belgium as his/her country and that he/she speaks English and Japanese may have initial affinity values of 0.25 for each of French, Flemish, English, and Japanese. In some cases, different information in the user profile may have different weights. Following the example of the second user, the initial language affinity values for the first user may be 0.2 for French and Flemish and 0.4 for English and Japanese in the case that identified languages in a user profile are weighted more heavily than inferred languages (e.g., inferred from country or location information).

The distribution value uᵢ (which include affinity values x of languages) for each user and the language value vⱼ for each media content item can be determined (e.g., computed, generated, calculated) using Bayesian updating and the following information:
playback information, including listenership of each media content item and listening history of each user; and
an assumption that the probability of a user interacting with a media content item depends on an overlap between the languages that the user knows and the language of the media content item (e.g., users are likely to listen to a podcast in a language that they understand and are not likely to listen to a podcast in a language that they do not understand).

Thus, knowledge of the playback data (also called listenership data, e.g., which users listen to which media content items) is vital to the determination (e.g., computation) of the languages of users and languages of media content items. The playback data can be illustrated (or represented) using a bipartite graph (shown below in FIGS. 5A-5E) that include a set of users 120 of the media-providing service, a set of media content items 124 that are provided by the media-providing service, and a set of edges that represent interactions between users 120 and media content items 124.

FIGS. 5A-5E illustrate the steps of updating the languages of media content items and the languages of users of a media-providing service as described with respect to FIG. 4.

FIG. 5A illustrates assigning initial language values to media content items 124, in accordance with some embodiments. The bipartite diagram shown in FIG. 5A corresponds to step 410 of FIG. 4. As shown, a respective media content item 124 is associated with a language indicator 126 that includes values that correspond to at least one language. In this example, the language indicators 126-1, 126-3, and 126-m show that the media content items 124-1, 124-3, and 124-m, respectively, have been assigned initial language values corresponding to English (e.g., the media content item 124-1, 124-3, and 124-m are determined to include audio that is in the English language). Media content item 124-2 has been assigned an initial language value corresponding to French, and media content item 124-4 has been assigned an initial language value corresponding to Chinese.

Note that not all users 120 of the media providing service and not all media content items provided by the media providing service are shown. Thus, each user 120 may interact with more media content items 124 than shown in FIGS. 5A-5E, and each media content item 124 may include other listeners than the ones shown in FIGS. 5A-5E. While not all relationships between each user 120 and each media content item 124 is shown in FIGS. 5A-5E, for the purpose of ease of explanation and illustration, it can be assumed that the shown users (e.g., users 120-1, 120-2, and 120-n) interact with only the media content items 124 that are shown in FIGS. 5A-5E.

In some embodiments, the initial language value of a respective media content item 124 is determined based on information in metadata associated with the respective media content item 124. For example, metadata of a respective media content item 124 may include information such as a title of the respective media content item 124, a description of the respective media content item 124, a producer or producing company of the respective media content item 124, and a language indicator for the respective media content item 124 that has been input by a creator or producer of the respective media content item 124 or that has been determined via natural language processing of information included in the metadata. For example, a media content item 124-2, which is a podcast, may include the name of a podcast producing company that is known to be based in Canada. Thus, the initial language value of the podcast may be determined to be English or French, or both (since English and French are the national languages of Canada). In this example, the initial language value is determined to be English. In another example, the creator of media content item 124-4 (e.g., author, producer, artist, person who uploads) may provide an indicator that the media content item 124-4 is in Chinese. Thus, the initial language of the media content item 124-4 is determined to be Chinese. In yet another example, a title of a media content item may include letters from the Russian alphabet and thus, the initial language value of the media content item 124—may be determined to be in Russian.

FIG. 5B illustrates determining languages of users 120 using initial language values of media content items 124, in accordance with some embodiments. The bipartite diagram shown in FIG. 5B corresponds to step 420 of FIG. 4. As shown, a user 120 of the media-providing service is associated with a language profile 122 that includes affinity values that correspond to different languages (e.g., k affinity values for k languages). The language of a respective user is determined based on the respective user's listening history and the languages of media content items in the respective user's listening history. In some embodiments, some weight for the user's affinity values is also based on a prior for the user's affinity values (e.g., based on their country of origin). In this example, user 120-1 is determined to know English and French based on the user having listened to media content items 124-1 and 124-3 which have initial language values corresponding to English, and media content item 124-2 which has an initial language value corresponding to French. Similarly, the language profile 122-2 of user 120-2 shows that user 120-2 is determined to know Chinese and English based on media content items 124-3 and 124-4 being part of the listening history of user 120-2. Lastly, user 120-n is determined to know English since all the media content items (including media content item 124-m) that are in the listening history of user 120-n have an initial value of English.

In some embodiments, as shown in language profiles 122-1 and 122-2, a user may be determined to know one or more languages and each language is associated with an affinity value that is representative of a frequency at which that user listens to or interacts with media content items in that language. For example, since 60% of the podcasts that user 120-1 listens to have an initial language that is English and 40% of the podcasts that user 120-1 listens to have an initial language that is French, the languages in the language profile 122-2 of user 120-1 have affinity values (0.6 for English, 0.4 for French, 0.0 for other languages) that are representative of the language distribution in a listening history of user 120-1 (e.g., 60% English and 40% French). Languages with an affinity value that is zero (e.g., 0.0) are not illustrated (e.g., only languages with affinity values that are non-zero are shown) in FIG. 5B for ease of illustration.

FIG. 5B (and description of step 420 provided above with respect to FIG. 4) illustrate how playback history (e.g., listenership of a media content item, listening history of a user) is an important factor in determining the languages of users 120 as well as the languages of media content items 124. In some embodiments, whether or not a user 120 of the media-providing service is a listener of a media content item 124 is determined based on an amount or frequency with which the user 120 has interacted with the media content item 124. For example, a threshold metric may be that a user is considered to be a listener of a podcast if the user has listened to at least one hour of the podcast (across any number of episodes). Another threshold metric may be that a user is considered to be a listener of a podcast if the user has listened to at least a predetermined number of episodes (e.g., at least 5 episodes) or a predetermined percent of all available episodes or all available content (e.g., at least 10% of episodes or at least 20% of the total audio run time of the show). Another example threshold metric is that a user is considered to be a listener of a podcast if the user listens to (e.g., plays, listens to at least one episode) the podcast with at least a predetermined frequency (e.g., at least once a month, at least once every quarter). Additionally, any threshold may be related to a time duration (e.g., within the last week, within the last year, since the user has joined the media-providing service). For example, a user is considered to be a listener of a podcast if the user has listened to at least one hour of the podcast (across any number of episodes) in the last month. Additionally, any number (e.g., one or more) thresholds may be used (e.g., employed) in determining a listenership of a media content item. In such cases, the user may be considered to be a listener of a podcast even if the user does not subscribe to or follow the podcast.

In some embodiments, a user 120 is determined to be a listener of a media content item 124 if the user 120 is subscribed to the media content item 124. For example, a user is considered to be a listener of a podcast if the user subscribes to a podcast and/or adds a podcast to a favorite list. In such cases, the user may be considered to be a listener of a podcast even if the user's listening history or listening pattern does not meet other thresholds (e.g., even if the user has not yet listened to at least 30 minutes of the podcast in the last month).

FIG. 5C illustrates determining updated language values of media content items 124 based on languages of users 120, in accordance with some embodiments. The bipartite diagram shown in FIG. 5C corresponds to steps 430 and 440 of FIG. 4. In this step, the language associated with (e.g., assigned to) a respective media content item 124 is determined based on the languages of users 120 that interact with the respective media content item 124. In this example, the listening history of the users 120 of the media-providing service may show that the most prevalent language (e.g., the most common language, the language with the highest prevalence) across listeners of media content item 124-1 is determined to be French. Thus, despite the fact that not all of the listeners of media content item 124-1 are determined to know French (e.g., user 120-n has a language profile 122-n that does not indicate that he/she knows French), the media content item 124-1 is determined to have an updated language that is French based on French being the most common languages across the listenership of media content item 124-1, and the language indicator 126-1 associated with media content item 124-1 is updated from English to “French”.

Note that the bipartite graph shown in FIGS. 5A-5E illustrates only a portion of some of the listenership. Thus, most of the listeners of media content item 124-1 may speak French, despite the fact that FIG. 5C illustrates a preponderance of English speakers.

Similarly, listening history of the users 120 of the media-providing service may show that the majority (e.g., the greatest percentage) of listeners of media content item 124-4 are determined to know English. Thus, based on the languages of the listeners of media content item 124-4, the media content item 124-4 is determined to have an updated language that is English, and the language indicator 126-4 associated with media content item 124-4 is updated to “English”. In this case, for example, it may be that the creator of media content item 124-4 incorrectly indicated that this podcast is in Chinese.

The distribution of the languages of the listeners of a media content item 124 may change over time. Some examples of how or why the distribution of the languages of the listeners of a media content item 124 may change include: the addition of new listeners (e.g., new listeners of a podcast, new subscribers), the removal of listeners (e.g., listeners stopped listening or unsubscribed), the addition or removal of users from the media-providing service, and users 120 of the media-providing service interacting with new media content items 124 or ceasing to interact with media content items 124 thereby causing their language profiles to change. Thus, any changes in the listenership of a media content item 124 or changes to a language profile 122 of a listener of a media content item 124 may prompt a language that is different from the initial language to be determined as the updated language of the media content item 124.

FIG. 5D illustrates updating languages of users 120 using updated language values of media content items 124, in accordance with some embodiments. The bipartite diagram shown in FIG. 5D corresponds to step 450 of FIG. 4. In this step, the language profile 122 of users 120 of the media-providing service are updated based on the updated languages of the media content items 124. Following the example laid out above with respect to FIGS. 5A-5C, the language profile 122 of all the users 120 are updated. As shown, the language indicator 126-1 of media content item 124-1 has been updated (as shown in FIG. 5C) to indicate that media content item 124-1 is in French and the language indicator 126-4 of media content item 124-4 has been updated (as shown in FIG. 5C) to indicate that media content item 124-4 is in English. Since users 120-1 and 122-n are listeners of media content item 124-1, the language profiles 122-1 and 122-n of users 120-1 and 120-n, respectively, have been updated. In this case, for user 120-1, affinity values have been updated to reflect the distribution of the languages of media content items 124 that user 120-1 interacts with (e.g., the affinity value for English has changed from 0.6 to 0.4 and the affinity value for French has changed from 0.4 to 0.6). The language profile 122-n of user 120-n has been updated to indicate that user 120-n knows both English and French since user 120-n interacts with media content items 124 that are determined to be in either English and/or French (e.g., the affinity value for English is changed from 1.0 to 0.5 and the affinity value for French is changed from 0.0 to 0.5). Similarly, language profile 122-2 of user 120-2 is updated to reflect that user 120-n is determined to know English, but not Chinese since user 120-2 does not interact with any media content items that are determined to be in the Chinese language (e.g., the affinity value for Chinese is changed from 1.0 to 0.0 and the affinity value for English is changed from 0.0 to 1.0).

FIG. 5E illustrates updating language values of media content items 124 based on updated languages of users 120, in accordance with some embodiments. The bipartite diagram shown in FIG. 5D corresponds to step 460 of FIG. 4. After the language profiles 122 of users 120 of the media-providing service have been updated (as shown in FIG. 5D), the language indicators 126 of media content items 124 are updated based on the updated language profiles 122 of the users 120. Keeping with the example laid out above with respect to FIGS. 5A-5D, the language indicator 126-m of media content item 124-m has been updated to indicate that the media content item 124-m is in French. In this example, a change in the distribution of the languages of listeners of media content item 124-m (based on the update to languages of users 120 in FIG. 5D) may indicate that French is the most prevalent language across all listeners of media content item 124-m. Thus, while many listeners of media content item 124-m may be determined to know languages other than French (such as user 120-n who is determined to know English and French), the language indicator 126-m of media content item 124-m is updated to reflect that the media content item 124-m is in French.

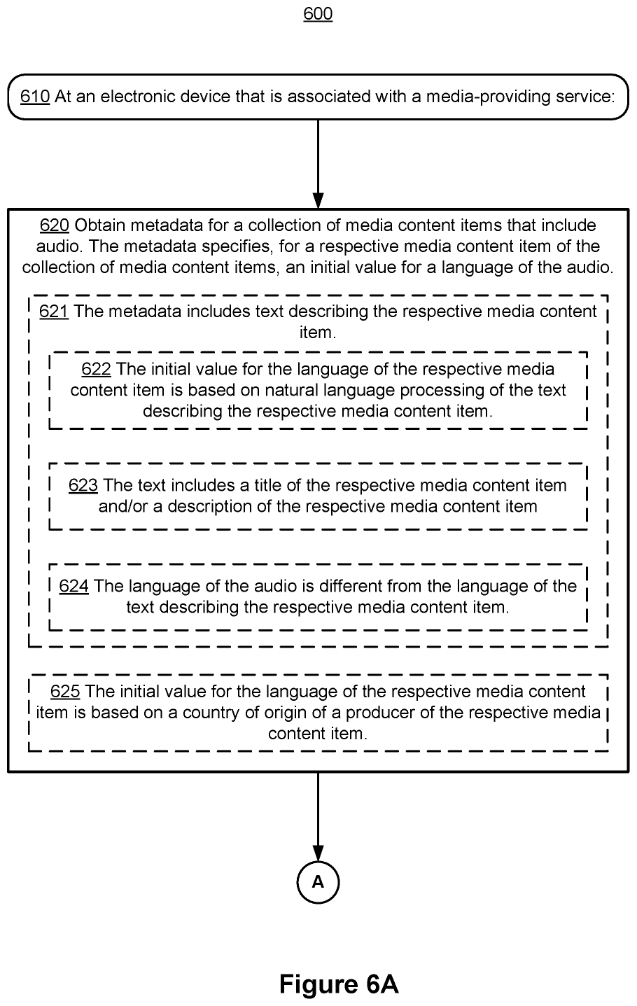

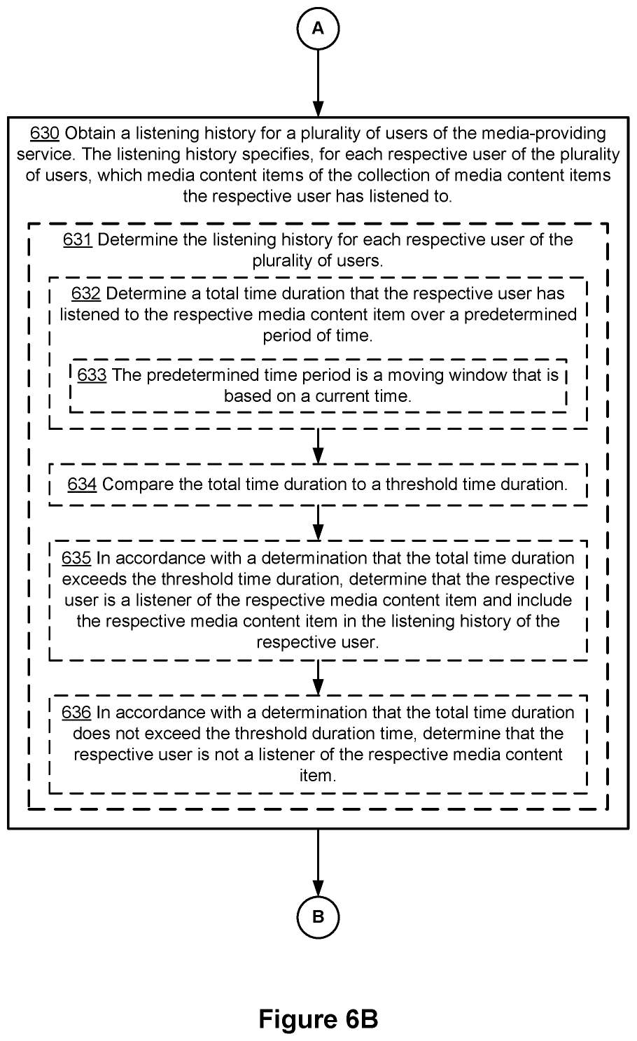

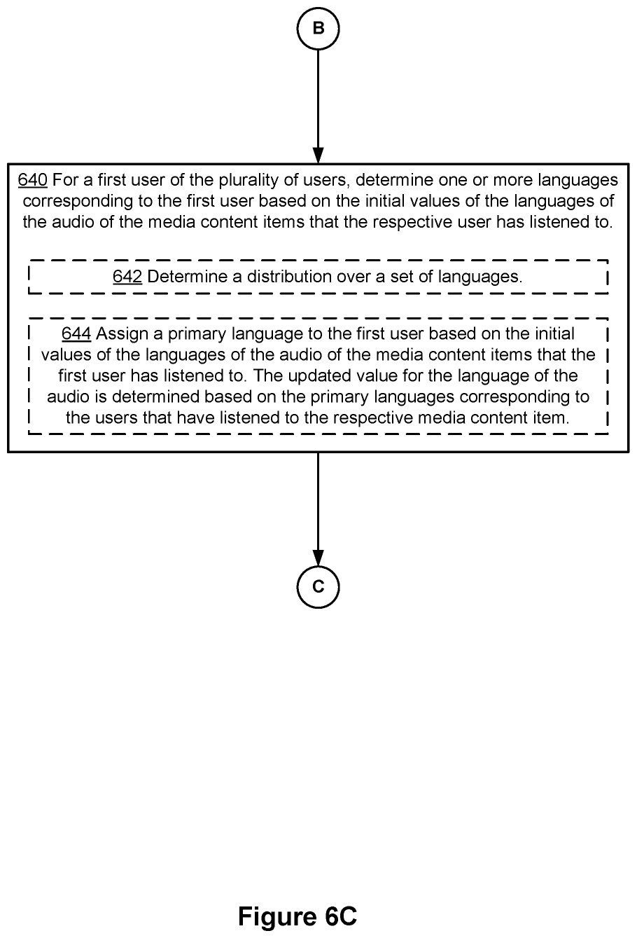

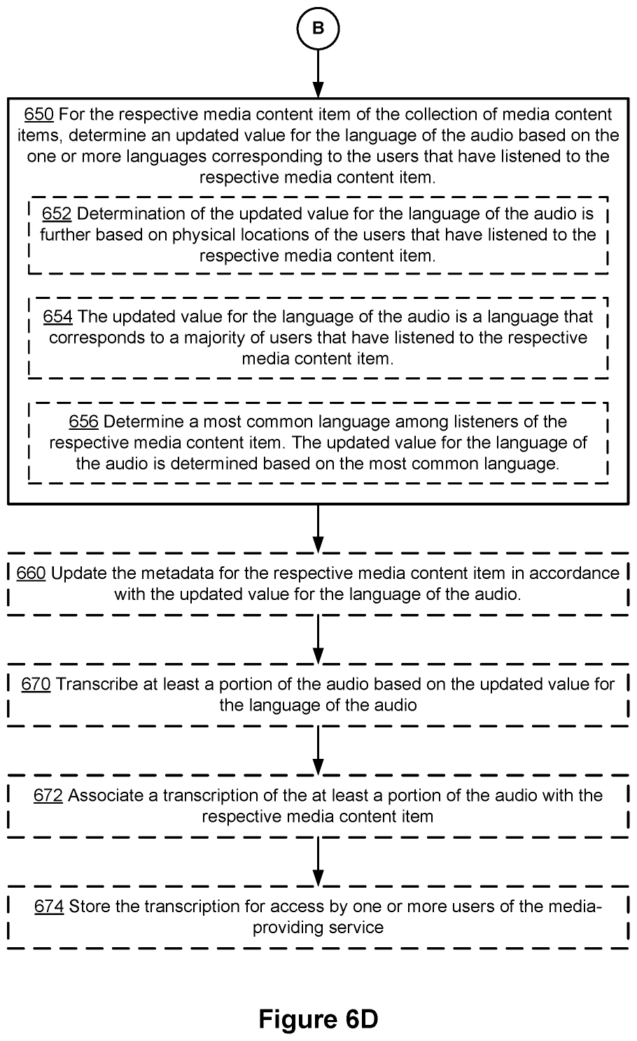

FIGS. 6A-6D are flow diagrams illustrating a method 600 for determining a language of a media content item 124, in accordance with some embodiments. Method 600 may be performed (610) at an electronic device (e.g., media content server 104), the first electronic device having one or more processors and memory storing instructions for execution by the one or more processors. In some embodiments, the method 600 is performed by executing instructions stored in the memory (e.g., memory 212, FIG. 2) of the electronic device.

In performing the method 600, an electronic device obtains (620) metadata for a collection of media content items 124 that include audio. The metadata specifies, for a respective media content item 124 of the collection of media content items, an initial value for a language of the audio (e.g., as shown in language indicator 126).

The electronic device obtains (630) a listening history (e.g., via listening history module 240, from listening history database 334) for a plurality of users 120 of the media-providing service. The listening history specifies, for each respective user 120 of the plurality of users, which media content items 124 of the collection of media content items the respective user has listened to.

For a first user of the plurality of users, the electronic device determines (640) one or more languages corresponding to the first user (e.g., user 120-1) based on the initial values of the languages of the audio of the media content items 124 that the respective user 120 has listened to.

For the respective media content item 124 of the collection of media content items, the electronic device determines (650) an updated value for the language of the audio based on the one or more languages corresponding to the users 120 that have listened to (e.g., are listeners of) the respective media content item 124.

In some embodiments, (621) the metadata includes text describing the respective media content item 124. For example, the metadata of a podcast may include a title and description of the podcast. In another example, the metadata of an audiobook may include the title and creator (e.g., producer, reader, author) of the audiobook.

In some embodiments, (622) the initial value for the language of the respective media content item 124 is based on natural language processing of the text describing the respective media content item 124. For example, the metadata may include a title of a podcast, such as “Welcome to ΩΓΣ.” Natural language processing of the title may determine (incorrectly or correctly) that the podcast is in Greek since it includes characters from the Greek alphabet. In another example, the metadata for a podcast may include a description, and natural language processing of the description may determine that the podcast is in English.

In some embodiments, (623) the text includes a title of the respective media content item 124 and/or a description of the respective media content item 124.

In some embodiments, (624) the language of the audio is different from the language of the text describing the respective media content item 124. For example, a podcast may have audio that is in Japanese, but the title may be in English.

In some embodiments, (625) the initial value for the language of the respective media content item 124 is based on a country of origin of a producer of the respective media content item 124. For example, the metadata for a podcast may include information that the podcast was produced by Acme Podcast Corporation (a fictitious Japanese company). In such cases, the initial value for the language of the podcast may be determined to be Japanese.

In some embodiments, obtaining (630) a listening history for a plurality of users 120 of the media-providing service includes (631) determining the listening history for each respective user 120 of the plurality of users, including: (632) determining a total time duration that the respective user 120 has listened to the respective media content item 124 over a predetermined period of time and (634) comparing the total time duration to a threshold time duration. In accordance with a determination that the total time duration exceeds the threshold time duration (635), the electronic device determines that the respective user 120 is a listener of the respective media content item 124 and includes the respective media content item 124 in the listening history of the respective user 120. In accordance with a determination that the total time duration does not exceed the threshold duration time (636), the electronic device determines that the respective user 120 is not a listener of the respective media content item 124. For example, a user 120 is determined (e.g., considered) to be a listener of a media content item 124 (e.g., a podcast) if the user 120 has listened to at least 30 minutes of the podcast (across any number of episodes) within the calendar year (e.g., since 0:00:00 AM on Jan. 1, 2020).

In some embodiments, (633) the predetermined time period is a moving window that is based on a current time. For example a user 120 is determined (e.g., considered) to be a listener of a media content item 124 (e.g., a podcast) if the user 120 has listened to at least 10 minutes of the podcast (across any number of episodes) within the last two months from a current date and time.

In some embodiments, determining (640) one or more languages corresponding to the first user includes determining (642) a distribution over a set of languages. As described above with respect to FIG. 4, a respective affinity value x for a user is associated with a specific language and provides a correlation (e.g., relationship) between a user and the specific language (e.g., a probability that the user knows the specific language). Thus, each user is associated with k number of affinity values x, and a respective affinity value x represents a frequency or amount of interaction of the user with that language. For example, a user that has an affinity value of 0.7 for English, 0.3 for Italian, and 0 for all other languages may be completely fluent or may have an equal proficiency (e.g., competency) in both English and Italian. However, the user may listen to more media content items that are in English compared to Italian. Thus, the affinity values can be considered to be representative of a number, an amount, or a frequency with which the user interacts with media content items in a certain language, and the affinity values do not necessarily represent a level of fluency (although in some cases, a level of fluency or proficiency in the language may be inferred or determined based on affinity values).

In some embodiments, determining (640) one or more languages corresponding to the first user (e.g., user 120-1) includes assigning (644) a primary language to the first user based on the initial values of the languages of the audio of the media content items 124 (e.g., media content items 124-1, 124-2, and 124-3, shown in FIG. 5B) that the first user has listened to. The updated value for the language of the audio is determined based on the primary languages corresponding to the users 120 that have listened to the respective media content item 124. For example, a language profile 122 of a user 120 may indicate that the user 120 knows a plurality of languages. In such a case, a primary language maybe determined for the user. In a specific example, a user's language profile 122 may indicate affinity values of 0.4 for Korean and 0.6 for Chinese. In this example, Chinese may be determined to be the user's primary language based on Chinese having the highest affinity value compared to all other languages for this user. In a second example, a user's language profile 122 may indicate affinity values of 0.4 for Russian and 0.6 for Afar. Additionally, the user's profile may also include that the user has indicated that he/she is from Russia or speaks Russian. In this example, the user's primary language may be considered to be Russian despite the user having a higher affinity value for Afar compared to Russian.

In some embodiments, (652) the determination of the updated value for the language of the audio is further based on physical locations of the users 120 that have listened to the respective media content item 124. For example, physical locations of users 120 or physical locations of devices that the user uses to interact with media content items 124 may be used to determine initial affinity values for the user. Thus, the languages of media content items 124 may be based upon the physical locations of users 120 or the physical locations of devices that the user uses to interact with media content items 124.

In some embodiments, (654) the updated value for the language of the audio is a language that corresponds to a majority of users that have listened to the respective media content item 124.

In some embodiments, determining (650) an updated value for the language of the audio is based on the one or more languages corresponding to the users 120 that have listened to the respective media content item 124 includes (656) determining a most common language among listeners of the respective media content item 124. The updated value for the language of the audio is determined based on the most common language. For example, a podcast called “Secrets to Great Italian Meals” may have 975 listeners. Of the 975 listeners, all 975 listeners have a non-zero affinity value for English, 900 listeners have a non-zero affinity value for Italian, and 100 listeners have a non-zero affinity value for Japanese. Since English is the most common language across all languages and across all listeners (in this case, all listeners are determined to know English) for this podcast, the most common language is determined to be English and thus, the podcast is determined to be in English.

In some embodiments, the electronic device also updates (660) the metadata for the respective media content item 124 in accordance with the updated value for the language of the audio. For example when the language of a podcast is determined to be English (based on the method described above with respect to FIGS. 4 and 5A-5E) and metadata associated with the podcast indicates that the language of the podcast is German, the metadata is updated to show that the podcast is in English.

In some embodiments, the electronic device also transcribes (670) at least a portion of the audio based on the updated value for the language of the audio, associates (672) a transcription of the at least a portion of the audio with the respective media content item, and stores (674) the transcription for access by one or more users of the media-providing service. For example, after the language of a podcast has been updated to German, the podcast is transcribed into German text and stored so that a user 120 can access (e.g., open, read, edit) the transcribed text.

Although FIGS. 6A-6D illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

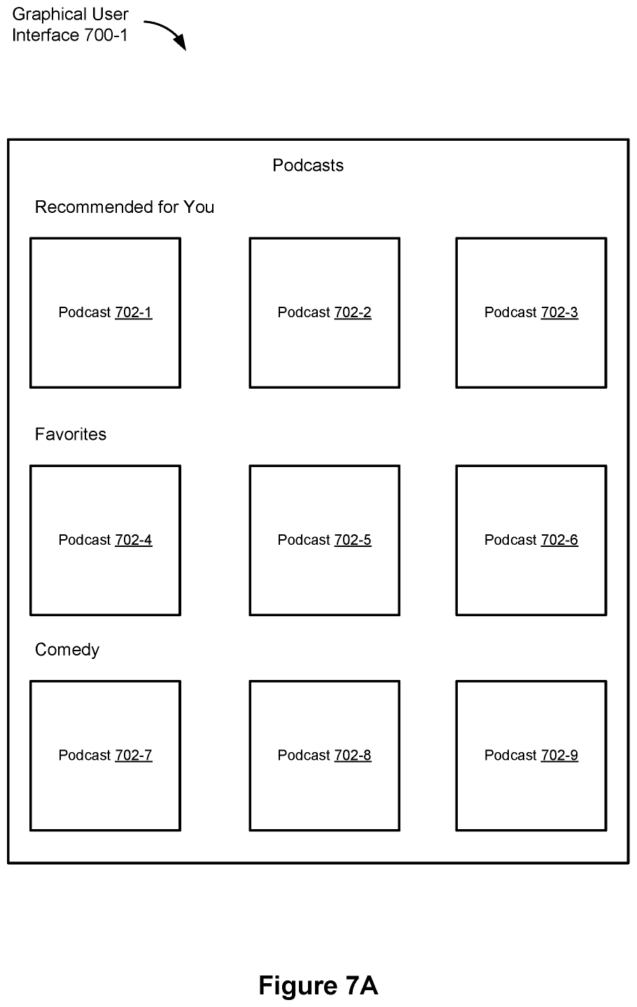

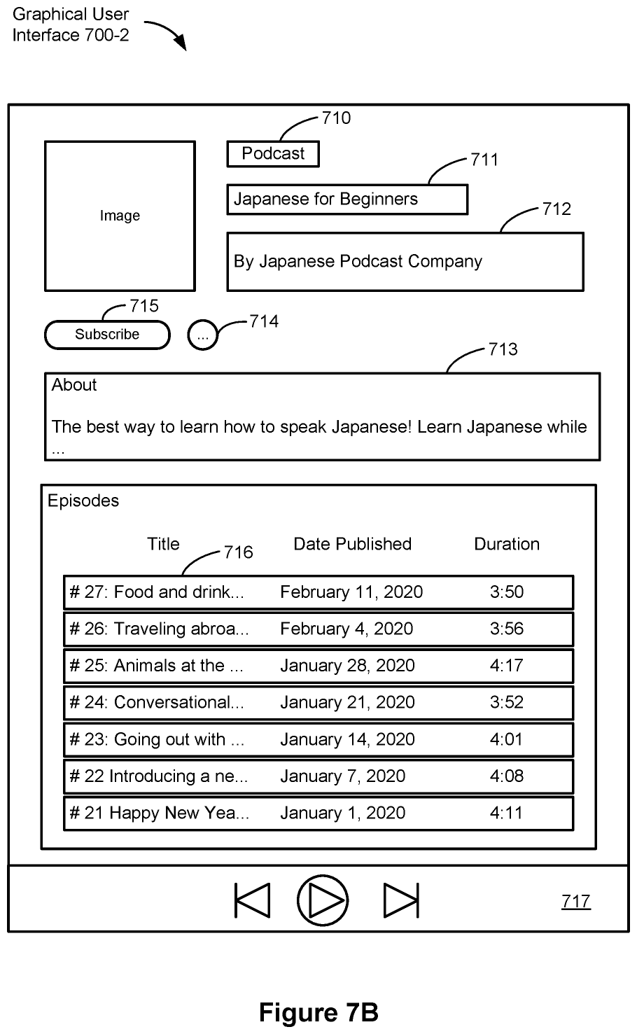

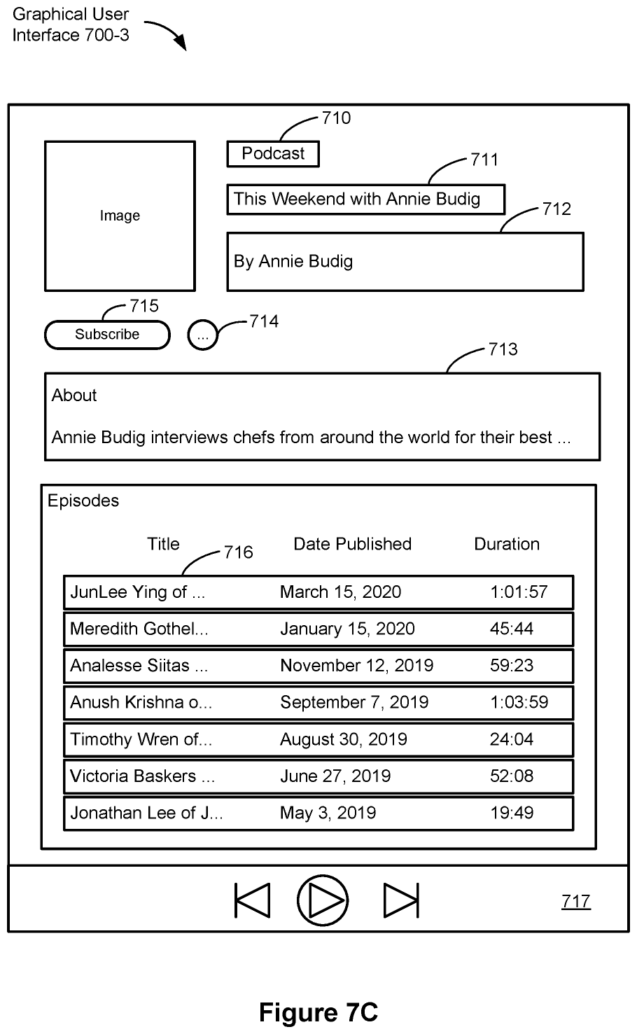

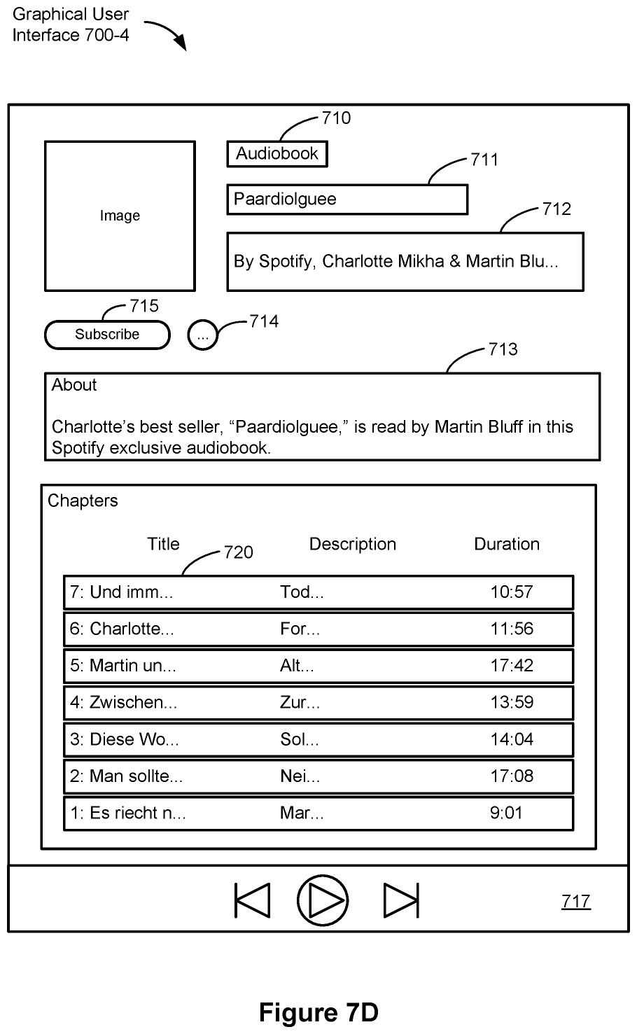

FIGS. 7A-7D illustrate a graphical user interface configured to display media content items 124 that are provided by a media-providing service. Graphical user interface 700 is configured to display any number of media content items 124 that are available. For example, FIG. 7A shows a graphical user interface 700-1 displaying a homepage screen that allows users to browse podcasts 702 (e.g., podcasts 702-1 through 702-9 which correspond to/are a type of media content item 124). In some embodiments, as shown, a user can browse media content items 124 (such as podcasts, songs, music albums, audio books, etc.) that are available through the media-providing service. In some embodiments, the media content items 124 may be separated by media content item type (e.g., music versus podcasts). In some embodiments, the media content items 124 may be separated by category, such as recommended podcasts, comedy podcasts, news podcasts, etc.

FIG. 7B shows a graphical user interface 700-2 displaying a media content item 124, which in this case is a podcast (e.g., a first podcast 702-1). In some embodiments, at least a portion of information stored in metadata associated with the media content item 124 is displayed in graphical user interface 700-2. For example, graphical user interface 700-2 displays an indicator 710 of the type of media (e.g., “podcast”), a name 711 of the media content item 124, an identifier 712 (such as an acronym, a name or an identifying number or code) of an creator or producer of the podcast (including artist, cast, original author, translator, etc.), and a description 713 of the media content item 124. In some embodiments, graphical user interface 700-2 includes a button 714 that allows a user to view additional information regarding the media content item 124. The graphical user interface 700-2 may also include a button 715 that allows a user to follow or subscribe to the media content item 124 such that the user receives updates when a new episode of the podcast has been uploaded or published. The graphical user interface 700-2 also displays episodes 716 associated with the media content item 124. In this example, the title, episode release date (e.g., episode publication date), and episode duration are also displayed. In some embodiments, an episode description or at least a portion of the episode description is also displayed in graphical user interface 700-2. The graphical user interface 700-2 also includes a control bar 717 that allows a user to navigate playback of media content items (e.g., play, pause, skip episodes).

As described above, in some embodiments, metadata corresponding to a media content item 124 may include contradicting information when it comes to language identification or language determination. For example, as shown in FIG. 7B, the podcast name and description are in English while the language indicated in metadata associated with the podcast is Japanese. The actual audio of the podcast (e.g., episodes of the podcast) are in Japanese. However, this may not be obvious or easily determined based on information in the metadata (e.g., the indicated language, the title, the description, etc.).

FIG. 7C shows a graphical interface 700-3 displaying a media content item 124, which in this case is a podcast (e.g., a second podcast 702-2 that is different from the first podcast 702-1). Details regarding graphical interface 700-3 that are the same as graphical interface 700-2 are not repeated here for brevity.

As described above, in some embodiments, metadata corresponding to a media content item 124 may include incorrect or mislabeled information. For example, the podcast shown in FIG. 7C includes audio that is in English. However, metadata associated with this podcast indicates that the podcast is in another language, Afar.

FIG. 7D shows a graphical interface 700-4 displaying a media content item 124, which in this case is an audiobook. Graphical interface 700-4 includes many similar features of graphical interfaces 700-2 and 700-3 (such as displaying a name, production company, description, etc. of the audiobook), which are not repeated here for brevity. In this example, since the media content item 124 is an audiobook, chapters 720 of the audiobook are displayed as well as a description of the chapter.

As described above, in some embodiments, metadata corresponding to a media content item 124 may include incorrect or mislabeled information. For example, the audiobook shown in FIG. 7D includes audio that is in German. However, metadata associated with this podcast indicates that the podcast is in English. Additionally, the description of the audiobook is in English and the title of the audiobook does not belong to any language (e.g., is a proper name or made up word).

The graphical user interfaces 700-1 through 700-4 are displayed on an electronic device, such as a computer, a smart phone, tablet, etc. In some embodiments, the graphical user interfaces 700-1 through 700-4 are displayed as part of an application (such as an application on a phone, tablet, smart device, or a desktop application). In some other embodiments, the graphical user interfaces 700-1 through 700-4 are displayed as part of a web application that is launched in a web browser.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A method, comprising:
at an electronic device with one or more processors and memory, wherein the electronic device is associated with a media-providing service:
obtaining metadata for a collection of media content items that include audio, wherein the metadata specifies, for a respective media content item of the collection of media content items, an initial value for a language of the audio;
obtaining a listening history for a plurality of users of the media-providing service, the listening history specifying, for each respective user of the plurality of users, which media content items of the collection of media content items the respective user has listened to;
for a first user of the plurality of users, determining one or more languages corresponding to the first user based on the initial values of the languages of the audio of the media content items that the respective user has listened to; and
for the respective media content item of the collection of media content items, determining an updated value for the language of the audio based on the one or more languages corresponding to the users that have listened to the respective media content item.

2. The method of claim 1, wherein determining the one or more languages corresponding to the first user comprises determining a distribution over a set of languages.

3. The method of claim 1, wherein the determination of the updated value for the language of the audio is further based on physical locations of the users that have listened to the respective media content item.

4. The method of claim 1, wherein the updated value for the language of the audio is a language that corresponds to a majority of users that have listened to the respective media content item.

5. The method of claim 1, wherein the metadata includes text describing the respective media content item.

6. The method of claim 5, wherein the initial value for the language of the respective media content item is based on natural language processing of the text describing the respective media content item.

7. The method of claim 5, wherein the text includes a title of the respective media content item and/or a description of the respective media content item.

8. The method of claim 5, wherein the language of the audio is different from the language of the text describing the respective media content item.

9. The method of claim 1, further comprising:
determining the listening history for each respective user of the plurality of users, including:
determining a total time duration that the respective user has listened to the respective media content item over a predetermined time period
comparing the total time duration to a threshold time duration;
in accordance with a determination that the total time duration exceeds the threshold time duration, determining that the respective user is a listener of the respective media content item and including the respective media content item in the listening history of the respective user; and
in accordance with a determination that the total time duration does not exceed the threshold duration time, determining that the respective user is not a listener of the respective media content item.

10. The method of claim 9, wherein the predetermined time period is a moving window that is determined based on a current time.

11. The method of claim 1, further comprising:
updating the metadata for the respective media content item in accordance with the updated value for the language of the audio.

12. The method of claim 1, further comprising:
assigning a primary language to the first user based on the initial values of the languages of the audio of the media content items that the first user has listened to, wherein the updated value for the language of the audio is determined based on the primary languages corresponding to the users that have listened to the respective media content item.

13. The method of claim 1, wherein the initial value for the language of the respective media content item is based on a country of origin of a producer of the respective media content item.

14. The method of claim 1, further comprising:
for the respective media content item, determining a most common language among listeners of the respective media content item, wherein the updated value for the language of the audio is determined based on the most common language.

15. The method of claim 1, further comprising:
transcribing at least a portion of the audio based on the updated value for the language of the audio;
associating a transcription of the at least a portion of the audio with the respective media content item; and
storing the transcription for access by one or more users of the media-providing service.

16. A server system of a media-providing service, comprising:
one or more processors; and
memory storing one or more programs for execution by the one or more processors, the one or more programs comprising instructions for performing a set of operations, comprising:
obtaining metadata for a collection of media content items that include audio, wherein the metadata specifies, for a respective media content item of the collection of media content items, an initial value for a language of the audio;
obtaining a listening history for a plurality of users of the media-providing service, the listening history specifying, for each respective user of the plurality of users, which media content items of the collection of media content items the respective user has listened to;
for a first user of the plurality of users, determining one or more languages corresponding to the first user based on the initial values of the languages of the audio of the media content items that the respective user has listened to; and
for the respective media content item of the collection of media content items, determining an updated value for the language of the audio based on the one or more languages corresponding to the users that have listened to the respective media content item.

17. A non-transitory computer-readable storage medium storing one or more programs configured for execution by a computer system associated with a media-providing service, the one or more programs comprising instructions for performing a set of operations, comprising:
obtaining metadata for a collection of media content items that include audio, wherein the metadata specifies, for a respective media content item of the collection of media content items, an initial value for a language of the audio;
obtaining a listening history for a plurality of users of the media-providing service, the listening history specifying, for each respective user of the plurality of users, which media content items of the collection of media content items the respective user has listened to;
for a first user of the plurality of users, determining one or more languages corresponding to the first user based on the initial values of the languages of the audio of the media content items that the respective user has listened to; and
for the respective media content item of the collection of media content items, determining an updated value for the language of the audio based on the one or more languages corresponding to the users that have listened to the respective media content item.
